(19) United States
(12) Patent Application Publication
(10) Pub. No.: US 2026/0208367 A1
(43) Pub. Date: Jul. 23, 2026

(54) CLEANING ROBOT AND METHOD FOR CONTROLLING THE SAME

(71) Applicant: SAMSUNG ELECTRONICS CO., LTD., Suwon-si (KR)

(72) Inventors: Juhyuk Kim, Suwon-si (KR); Minwoo Ryu, Suwon-si (KR); Taegyu Kim, Suwon-si (KR); Jinhee Kim, Suwon-si (KR)

(73) Assignee: SAMSUNG ELECTRONICS CO., LTD., Suwon-si (KR)

(21) Appl. No.: 19/410,694

(22) Filed: Dec. 5, 2025

Related U.S. Application Data
(63) Continuation of application No. PCT/KR2025/018108, filed on Nov. 6, 2025.

(30) Foreign Application Priority Data
Jan. 20, 2025 (KR) 10-2025-0008322

(51) Int. Cl. B25J 11/00; B25J 9/16; B25J 13/08

(52) U.S. Cl. CPC B25J 11/0085; B25J 9/161; B25J 9/1697; B25J 13/08

(57) ABSTRACT

A cleaning robot includes at least one wheel; an object detection sensor; memory storing at least one instruction; and at least one processor, wherein the at least one instruction, when executed by the at least one processor, individually or collectively, causes the cleaning robot to obtain detection information corresponding to an object via the object detection sensor; identify a height of the object, shape information of the object, and surrounding environment information of the object based on the detection information; store a cleaning space map including the shape information and the surrounding environment information; determine whether the object corresponds to a door threshold that is traversable by the cleaning robot based on (i) the height, (ii) the shape information, and (iii) the surrounding environment information; and based on the object corresponding to the door threshold, control the at least one wheel to move the cleaning robot to traverse the object.

### CROSS-REFERENCE TO RELATED APPLICATIONS

This application is a by-pass continuation application of International Application No. PCT/KR2025/018108, filed on Nov. 6, 2025, which is based on and claims priority to Korean Patent Application No. 10-2025-0008322, filed on Jan. 20, 2025, in the Korean Intellectual Property Office, the disclosures of which are incorporated by reference herein in their entireties.

### BACKGROUND

### 1. Field

The disclosure relates to a cleaning robot capable of detecting an object, and a method for controlling the same.

### 2. Description of Related Art

A cleaning robot may identify objects located in an indoor space while moving within the indoor space, and may generate a map of the indoor space. The cleaning robot may clean the indoor space using the map of the indoor space. In addition, the cleaning robot may collect environmental data of the indoor space. The cleaning robot may perform cleaning by driving itself in the area to be cleaned without user operation.

In general, cleaning robots apply an algorithm that distinguishes between objects to be traversed (e.g., carpets) and objects to be avoided (e.g., general obstacles) when detecting obstacles on a driving path. However, in such a case, a door threshold is not separately distinguished, which may result in indiscriminately moving across different spaces during cleaning, or failure to enter due to cliff detection sensors'detection while traversing a door threshold.

In addition, in a case where a function is provided that allows the user to manually specify a door threshold through an application or the like, the user needs to have an understanding of the entire driving map and manually designate the locations.

### SUMMARY

An aspect of the disclosure provides a cleaning robot that may automatically detect a door threshold during driving and establish an optimized driving plan according to the characteristics of the detected door threshold, and a method for controlling the cleaning robot.

In addition, the cleaning robot and the method for controlling the same may enable efficient cleaning by automatically determining whether the cleaning robot may traverse a door threshold according to the height of the door threshold and setting a driving path based on the determination.

Technical aspects that can be achieved by the disclosure are not limited to the above-mentioned aspects, and other technical aspects not mentioned will be clearly understood by one of ordinary skill in the technical art to which the disclosure belongs from the following description.

According to an aspect of the disclosure, a cleaning robot includes at least one wheel; an object detection sensor; memory storing at least one instruction; and at least one processor, wherein the at least one instruction, when executed by the at least one processor, individually or collectively, causes the cleaning robot to obtain detection information corresponding to a first object via the object detection sensor; identify a height of the first object, shape information of the first object, and surrounding environment information of the first object based on the detection information; store a cleaning space map including the shape information and the surrounding environment information; determine whether the first object corresponds to a first door threshold that is traversable by the cleaning robot based on (i) the height, (ii) the shape information, and (iii) the surrounding environment information; and based on the first object corresponding to the first door threshold, control the at least one wheel to move the cleaning robot to traverse the first object.

The at least one instruction, when executed by the at least one processor, individually or collectively, may cause the cleaning robot to determine that the first object corresponds to the first door threshold based on the height of the first object being less than a reference height.

The at least one instruction, when executed by the at least one processor, individually or collectively, may cause the cleaning robot to reduce the reference height in response to the cleaning robot failing to traverse the first object more than a reference number of times.

The at least one instruction, when executed by the at least one processor, individually or collectively, may cause the cleaning robot to, in response to the reference height being reduced re-determine whether the first object corresponds to the first door threshold; and reset a driving path of the cleaning robot based on a result of the re-determination.

The cleaning robot may further include a communication interface, and the at least one instruction, when executed by the at least one processor, individually or collectively, may cause the cleaning robot to change the reference height based on receiving a command, via the communication interface, from an external device.

The at least one instruction, when executed by the at least one processor, individually or collectively, may cause the cleaning robot to receive an input to add a door threshold region from an external device via the communication interface; and determine whether a second object in the door threshold region corresponds to a second door threshold based on an identified height of the second object.

The at least one instruction, when executed by the at least one processor, individually or collectively, may cause the cleaning robot to, in response to receiving an input to delete a door threshold region from the external device, reset a driving path of the cleaning robot based on identifying a third object in the deleted door threshold region as an obstacle.

The at least one instruction, when executed by the at least one processor, individually or collectively, may cause the cleaning robot to reset a driving path of the cleaning robot based on determining whether the first object corresponds to the first door threshold.

The shape information may include information indicating at least one of an area of the first object or a width of the first object.

The surrounding environment information may include information indicating whether a wall exists in a vicinity of the first object.

The at least one instruction, when executed by the at least one processor, individually or collectively, may cause the cleaning robot to transmit to the external device, via the communication interface (i) information indicating whether the first object corresponds to the first door threshold and (ii) information indicating the driving path that was reset.

According to an aspect of the disclosure, a method for controlling a cleaning robot includes obtaining detection information corresponding to an object via the object detection sensor; identifying a height of the object, shape information of the object, and surrounding environment information of the object based on the detection information; storing a cleaning space map including the shape information and the surrounding environment information; determining whether the object corresponds to a door threshold that is traversable by the cleaning robot based on (i) the height, (ii) the shape information, and (iii) the surrounding environment information; and based on the object corresponding to the door threshold, controlling at least one wheel of the cleaning robot to move the cleaning robot to traverse the object.

The determining whether the object corresponds to the door threshold may include determining that the object corresponds to the door threshold based on the height of the object being less than a reference height.

The method may further include reducing the reference height in response to the cleaning robot failing to traverse the object more than a reference number of times.

The method may further include, in response to the reference height being reduced, re-determining whether the object corresponds to the door threshold; and resetting a driving path of the cleaning robot based on a result of the re-determination.

The method may further include changing the reference height, based on receiving a command, via a communication interface, from an external device.

The method may further include receiving an input to add a door threshold region from an external device via the communication interface; and determining whether a second object in the door threshold region corresponds to a second door threshold based on an identified height of the second object.

The method may further include, in response to receiving an input to delete a door threshold region from the external device, resetting a driving path of the cleaning robot based on identifying a third object in the deleted door threshold region as an obstacle.

The method may further include resetting a driving path of the cleaning robot based on determining whether the first object corresponds to the first door threshold.

According to an aspect of the disclosure, a non-transitory computer-readable recording medium having at least one instruction recorded thereon, that, when executed by at least one processor of a cleaning robot, individually or collectively, causes the at least one processor to obtain detection information corresponding to an object via the object detection sensor; identify a height of the object, shape information of the object, and surrounding environment information of the object based on the detection information; store a cleaning space map including the shape information and the surrounding environment information; determine whether the object corresponds to a door threshold that is traversable by the cleaning robot based on (i) the height, (ii) the shape information, and (iii) the surrounding environment information; and based on the object corresponding to the door threshold, control at least one wheel of the cleaning robot to move the cleaning robot to traverse the object.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 illustrates a cleaning robot according to an embodiment.

FIG. 2 illustrates a lower portion of a cleaning robot according to an embodiment.

FIG. 3 illustrates a state in which a pad holder is separated from a cleaning robot according to an embodiment.

FIG. 4 is a control block diagram of a cleaning robot according to an embodiment of the disclosure.

FIG. 5 is a flowchart illustrating a method for controlling a cleaning robot according to an embodiment of the disclosure.

FIG. 6 is a diagram illustrating various objects in a cleaning space according to an embodiment of the disclosure.

FIGS. 7A and 7B are diagrams illustrating a determination of whether an object is a door threshold according to a height of the object according to an embodiment of the disclosure.

FIG. 8 is a flowchart illustrating a process of attempting a door threshold traversal and reducing a reference height according to an embodiment of the disclosure.

FIG. 9 is a flowchart illustrating a process of changing a reference height according to user input according to an embodiment of the disclosure.

FIG. 10 is a flowchart illustrating a process of adding a door threshold region according to user input according to an embodiment of the disclosure.

FIG. 11 is a flowchart illustrating a process of deleting a door threshold region according to user input according to an embodiment of the disclosure.

FIG. 12 is a diagram illustrating a notification provided to an external device according to an embodiment of the disclosure.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

For example, “at least one of A, B, or C” may include ‘A’, ‘B’, ‘C’, ‘A and B’, ‘B and C’, ‘A and C’, and ‘A, B and C’.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

Hereinafter, an operation principle and embodiments will be described in detail with reference to the accompanying drawings.

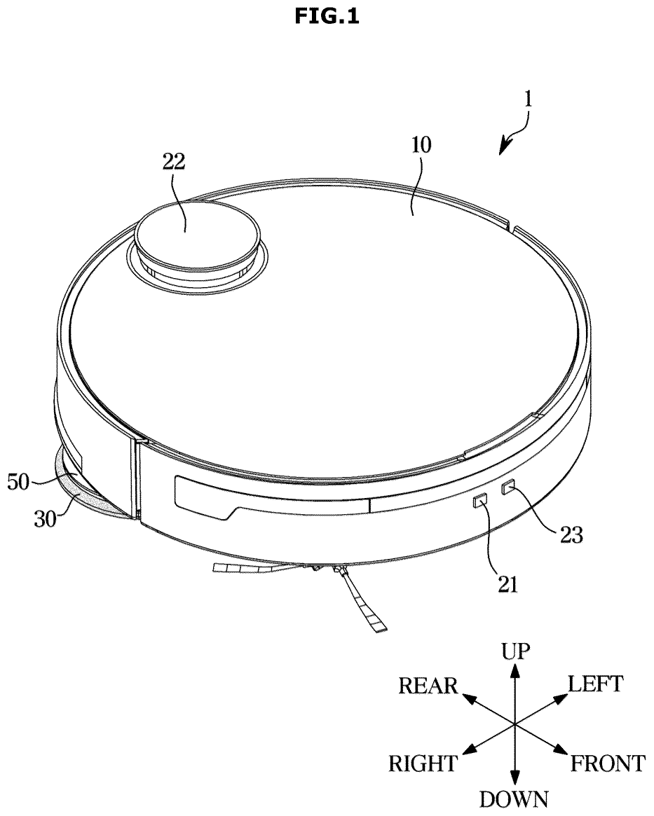

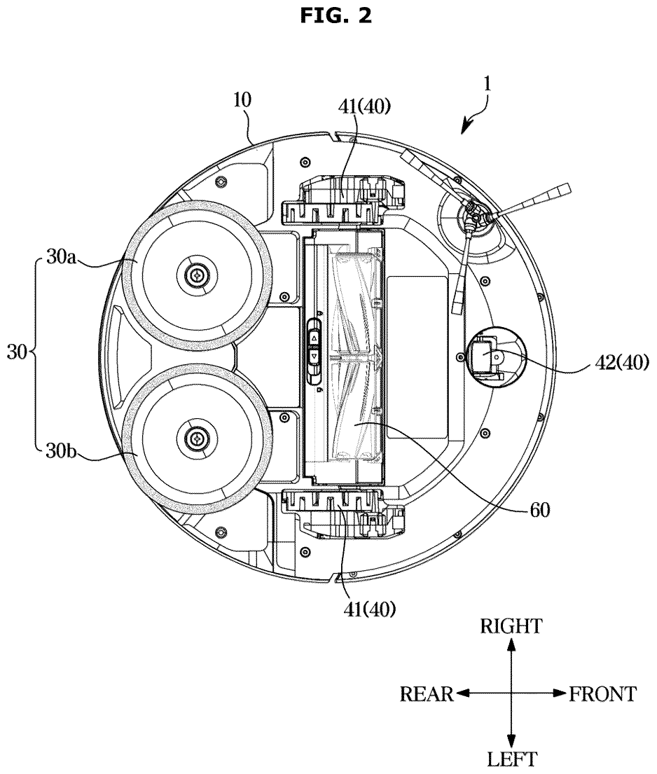

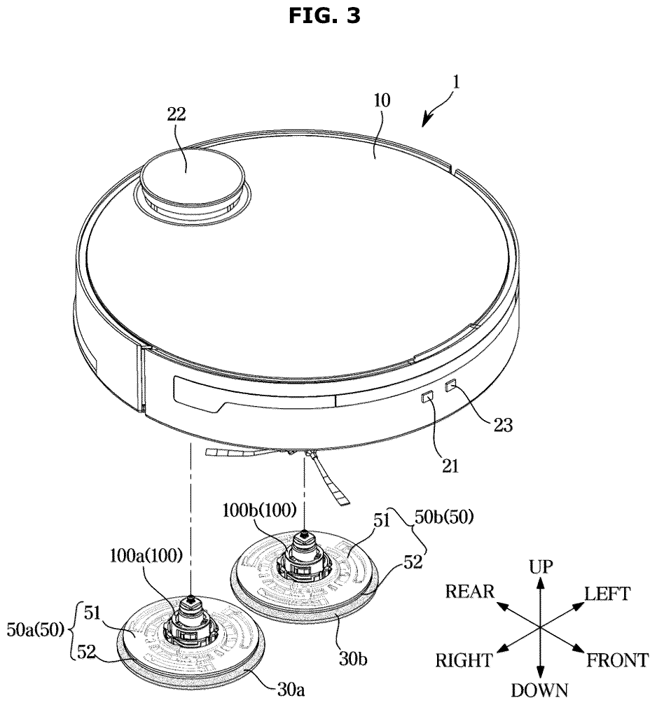

FIG. 1 illustrates a cleaning robot according to an embodiment. FIG. 2 illustrates a lower portion of the cleaning robot according to an embodiment. FIG. 3 illustrates a state in which a pad holder is separated from the cleaning robot according to an embodiment.

Terms such as front, rear, upper, lower, left, and right in the drawings are defined based on the direction in which a cleaning robot 1 moves forward, but the shapes and positions of each component are not limited by these terms. In addition, expressions that indicate a direction are used to clearly understand the disclosure, and the direction may be defined otherwise.

Referring to FIG. 1, FIG. 2, and FIG. 3, the cleaning robot 1 may include a main body 10, and wheels 41 that are rotatable with respect to an axis horizontal to the ground and move the main body 10. The main body 10 may include a case forming an exterior. A plurality of wheels 41 may be provided. For example, two main wheels 41 and an auxiliary wheel 42 may be provided at a lower portion of the main body 10. The wheels 41 may include a wheel motor, and may rotate by the rotational force generated by the wheel motor.

A brush 60 may be provided at a lower portion of the main body 10. The brush 60 may scatter foreign substances present on the driving path of the main body 10. The brush 60 is provided in an inlet formed on a bottom of the main body 10, and scatters foreign substances into the inlet while rotating around a rotation axis perpendicular to the front of the main body 10. An intake fan 61 for generating suction force to draw in foreign substances and a dust bin for storing foreign substances may be provided inside the main body 10.

The cleaning robot 1 may include various sensors. For example, the cleaning robot 1 may include at least one of a camera 21, a light detection and ranging (lidar) sensor 22, or an ultrasonic sensor 23. Various sensors may be provided in/on the main body 10. At least some of the various sensors may be exposed to the outside of the main body 10. The camera 21, the lidar sensor 22, and the ultrasonic sensor 23 may be provided at the front, side, rear, and/or upper portion of the main body 10.

The camera 21 may be provided at the front of the main body 10. The camera 21 may include a camera. The camera 21 may generate an image with a field of view (FOV) facing the front of the main body 10. The position of the camera 21 is not limited to the front of the main body 10. The camera 21 may rotate and photograph the surroundings of the cleaning robot 1. Other cameras may be further provided at the side and/or rear of the main body 10.

The camera 21 may include an image sensor that collects light incident from the outside to generate image information. For example, the camera 21 may include at least one of an RGB camera that collects visible light and generates a color image, or an infrared camera that generates an infrared image. The camera 21 may include a binocular camera (stereo camera). The binocular camera may obtain depth information of an object using disparity between both eyes. The image information obtained by the camera 21 may be transmitted to a controller 300 of the cleaning robot 1. The controller 300 may process the image information to identify an object (external object) in a vicinity of the cleaning robot 1. The controller 300 may identify the type of floor being cleaned from the image obtained by the camera 21.

The lidar sensor 22 may emit light (pulse laser) to the outside, and receive the reflected light from an external object in a preset direction. The lidar sensor 22 may rotate 360 degrees clockwise or counterclockwise. Because the lidar sensor 22 may emit light across 360 degrees and receive reflected light, the cleaning robot 1 may use the lidar sensor 22 to detect external objects from all directions.

Lidar data generated by the lidar sensor 22 may be transmitted to the controller 300 of the cleaning robot 1. The lidar data may include light propagation direction information and information about a distance to an external object. The controller 300 may process the lidar data to perform three-dimensional (3D) modeling of an indoor space. The controller 300 may process the lidar data to obtain 3D data of external objects. The controller 300 may identify the type of floor being cleaned from the lidar data obtained by the lidar sensor 22.

The ultrasonic sensor 23 may emit ultrasonic waves, and receive echo signals reflected from an object. The controller 300 of the cleaning robot 1 may identify the presence of the object and calculate a distance to the object based on ultrasonic data including a time difference between the ultrasonic waves emitted by the ultrasonic sensor 23 and the received echo signals. The controller 300 may identify the type of floor being cleaned from the ultrasonic data obtained by the ultrasonic sensor 23.

In addition to the above described components, various sensors may be included in the cleaning robot 1. For example, the cleaning robot 1 may further include at least one of an impact sensor detecting impact with an external object, a motion sensor detecting movement and rotation of the cleaning robot 1, a wheel sensor detecting rotation and speed of the wheel, a time-of-flight (ToF) sensor measuring a distance to an external object, a radio frequency (RF) sensor, or a radar sensor.

The cleaning robot 1 may include a wet cleaning pad 30 and a pad holder 50. The wet cleaning pad 30 may refer to a mop. The wet cleaning pad 30 may be made of various materials (e.g., fabric, sponge, etc.). The wet cleaning pad 30 may be attached to the pad holder 50.

The pad holder 50 may be rotatable at a lower portion of the main body 10. The wet cleaning pad 30 may rotate according to the rotation of the pad holder 50. Wet cleaning may be performed as the wet cleaning pad 30 contacts and rotates on the floor to be cleaned. The wet cleaning pad 30 and the pad holder 50 may be formed in a disc shape.

Two wet cleaning pads 30 and two pad holders 50 may be provided. For example, a first wet cleaning pad 30a and a first pad holder 50a may be located at the lower right of the main body 10. A second wet cleaning pad 30b and a second pad holder 50b may be located at the lower left of the main body 10. The number of wet cleaning pads 30 and pad holders 50 may vary depending on the design.

The pad holder 50 may include a holder body 51 and a rotating plate 52. Velcro for attaching the wet cleaning pad 30 may be provided on at least a portion of the lower side of the holder body 51. The holder body 51 and the rotating plate 52 may be detachably coupled. The rotating plate 52 may rotate according to the operation of a motor 80, which will be described below. As the rotating plate 52 rotates, the holder body 51 may rotate together. The holder body 51 and the rotating plate 52 may each be formed in a disc shape.

The pad holder 50 may be lowered toward the floor as the pad holder 50 rotates in a predetermined forward direction. The pad holder 50 may be raised toward the main body 10 as the pad holder 50 rotates in a reverse direction opposite to the forward direction. A lifting assembly 100 that enables the descent or ascent of the pad holder 50 may be provided.

In a case where a plurality of pad holders 50 are provided, a plurality of lifting assemblies 100 corresponding to the plurality of pad holders 50 may be provided. For example, the cleaning robot 1 may include a first lifting assembly 100a that lowers or raises the first pad holder 50a, and a second lifting assembly 100b that lowers or raises the second pad holder 50b. The first lifting assembly 100a and the second lifting assembly 100b may have the same structure.

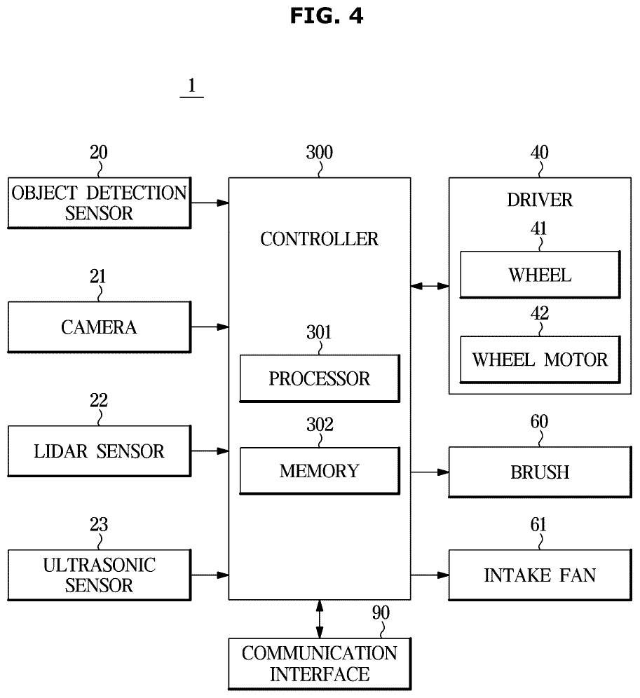

FIG. 4 is a control block diagram of a cleaning robot according to an embodiment of the disclosure.

As described above, the cleaning robot 1 may include the camera 21, the lidar sensor 22, the ultrasonic sensor 23, the wheels 41, the brush 60, and the intake fan 61.

In addition, the cleaning robot 1 may include an object detection sensor 20 for detecting an object, a communication interface 90 for communicating with an external device, and the controller 300. The controller 300 may include at least one processor 301 and memory 302.

The communication interface 90 may include at least one of a short-range wireless communication module or a long-range wireless communication module.

The communication interface 90 may transmit data to an external device (e.g., a server, a user device, and/or a home appliance) or receive data from an external device. For example, the communication interface may establish communication with a server and/or a user device and/or a home appliance, and transmit and receive various data.

To this end, the communication interface 90 may support the establishment of a direct (e.g., wired) communication channel or a wireless communication channel between external devices, and the performance of communication through the established communication channel. According to an embodiment, the communication interface 90 may include a wireless communication module (e.g., a cellular communication module, a short-range wireless communication module, or a global navigation satellite system (GNSS) communication module) or a wired communication module (e.g., a local area network (LAN) communication module, or a power line communication module). The corresponding communication module among these communication modules may communicate with an external device through a first network (e.g., a short-range wireless communication network, such as Bluetooth, wireless fidelity (Wi-Fi) direct, or infrared data association (IrDA)) or a second network (e.g., a long-range wireless communication network, such as a legacy cellular network, a 5G network, a next-generation communication network, the Internet, or a computer network (e.g., LAN or WAN)). These various types of communication modules may be integrated into a single component (e.g., a single chip) or may be implemented as a plurality of separate components (e.g., a plurality of chips).

The short-range wireless communication module may include a Bluetooth communication module, a Bluetooth low energy (BLE) communication module, a near field communication module, a wide LAN (WLAN) (Wi-Fi) communication module, a Zigbee communication module, an infrared data association (IrDA) communication module, a Wi-Fi direct (WFD) communication module, an ultrawideband (UWB) communication module, an Ant+ communication module, a microwave uWave communication module, and the like, but is not limited thereto.

The long-range wireless communication module may include a communication module that perform various types of long-range wireless communication, and may include a mobile communication interface. The mobile communication interface transmits and receives radio signals to and from at least one of a base station, an external terminal, and a server on a mobile communication network.

In an embodiment, the communication interface 90 may communicate with an external device, such as a server, a user device, or another home appliance through a nearby access point (AP). The AP may connect a local area network (LAN) to which the cleaning robot 1 or the user device is connected to a wide area network (WAN) to which the server is connected. The cleaning robot or the user device may be connected to the server through the wide area network (WAN).

The controller 300 may include the memory 302 that stores control programs and control data for controlling a driver 40, the brush 60, the intake fan 61, and the like, and at least one processor 301 that generates control signals according to the control programs and control data stored in the memory 302. The memory 302 and the processor 301 may each be implemented as separate chips. The processor 301 may include one or more processor chips or one or more processing cores. The memory 302 may include one or more memory chips or one or more memory blocks. In addition, the memory 302 and the processor 301 may be implemented as a single chip.

The memory 302 may store programs and data for controlling the driver 40, the brush 60, the intake fan 61, and the like. In addition, the memory 302 may store a cleaning space map including shape information and surrounding environment information about an object, which will be described below.

The memory 302 may include volatile memory, such as dynamic random access memory (DRAM), and static RAM (SRAM) for temporarily storing data. In addition, the memory 302 may include non-volatile memory, such as read only memory (ROM), erasable programmable read only memory (EPROM), and electrically erasable programmable read only memory (EEPROM) for long-term data storage.

The processor 301 may include various logic circuits and arithmetic circuits, and may process data according to the program provided from the memory 302, and generate control signals according to the processing result.

In a case where a method according to at least one embodiment of the disclosure includes a plurality of operations, the plurality of operations may be performed by a single processor, or by a plurality of processors. For example, in a case where a first operation, a second operation, and a third operation are performed by a method according to at least one embodiment, the first operation, the second operation, and the third operation may all be performed by a first processor, and alternatively, the first operation and the second operation may be performed by the first processor (e.g., a general-purpose processor) and the third operation may be performed by a second processor (e.g., an artificial intelligence (AI)-specific processor).

The controller 300 may be electrically connected to the various sensors 20, 21, 22, and 23, the driver 40, the communication interface 90, and the like.

The cleaning robot 1 may include the object detection sensor 20 detecting objects. Here, the object detection sensor may be a 3D sensor.

The 3D sensor is a sensor that may obtain a distance to a target object and depth information in a 3D space. 3D sensors may be broadly classified into time of flight (TOF) and structured light methods according to their operating principles.

A TOF 3D sensor may emit pulsed infrared rays or lasers, and may calculate distance by measuring the time it takes for the optical signal to be reflected from an object and return. That is, by measuring the time it takes for the emitted optical signal to reach the object, reflect, and return to the sensor, the distance to the object and 3D shape information may be obtained.

A structured light 3D sensor may project an infrared ray with a specific pattern, and obtain 3D information by analyzing how the pattern is distorted on the object. That is, an image sensor captures the distorted shape of the projected pattern on the surface of the object, and the depth and shape of the object may be calculated by analyzing the degree of the distortion.

Through the above processes, the object detection sensor 20 may detect the distance to the object and the height of the object.

The at least one processor 301 may determine whether the object corresponds to a door threshold based on the height of the object detected by the object detection sensor 20, and the shape information about the object and surrounding environment information about the object stored in the memory 302. Details thereof will be described below.

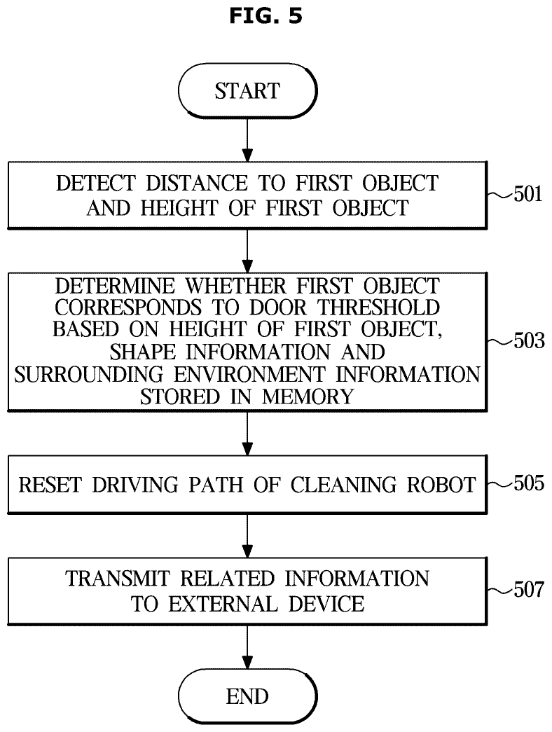

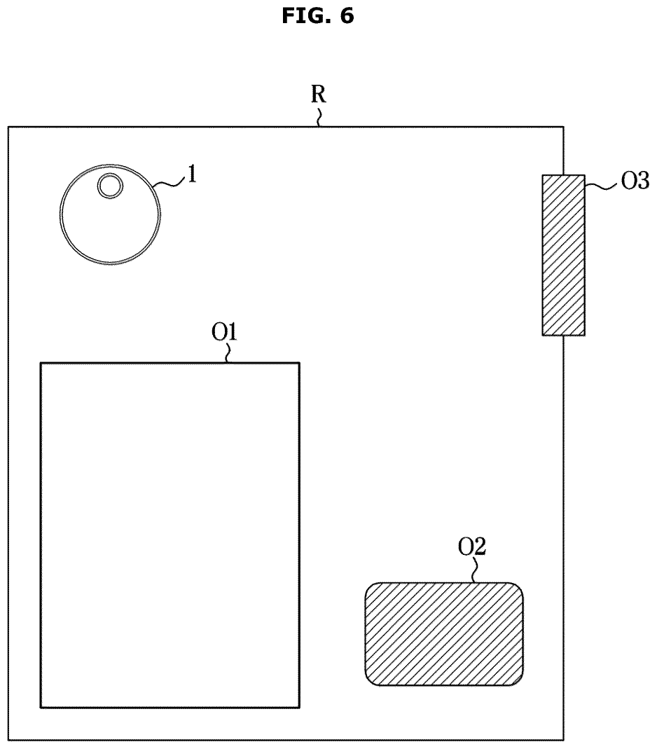

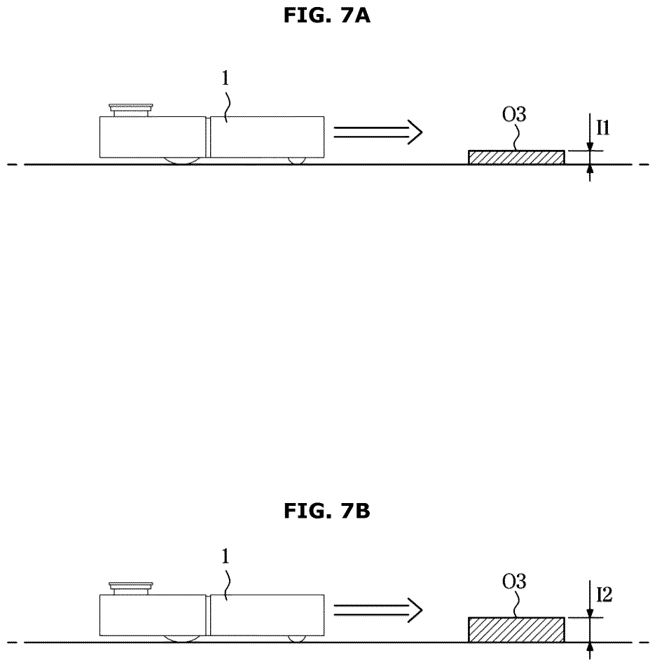

FIG. 5 is a flowchart illustrating a method for controlling a cleaning robot according to an embodiment of the disclosure. FIG. 6 is a diagram illustrating various objects in a cleaning space according to an embodiment of the disclosure. FIG. 7 is a diagram illustrating determination of whether an object corresponds to a door threshold according to a height of the object according to an embodiment of the disclosure.

As described above, the object detection sensor may detect a distance to a first object and a height of the first object (501). As shown in FIG. 6, a distance to and a height of each of the objects O1, O2, and O3 may be detected.

The object 1 O1 may be an object that the cleaning robot 1 may traverse, such as a carpet, and the object 2 O2 may be an obstacle that the cleaning robot 1 cannot traverse, such as drawers. The object 3 O3 may correspond to a threshold (door threshold).

The at least one processor 301 may determine whether a first object corresponds to a first door threshold that is traversable by the cleaning robot based on the height of the first object detected by the object detection sensor 20, the shape information, and the surrounding environment information stored in the memory 302 (503).

As described above, the cleaning robot 1 may include various sensors, such as the object detection sensor 20, the camera 21, the lidar sensor 22, and the ultrasonic sensor 23. The surrounding environment information may be obtained based on the detection results of the above sensors. For example, the surrounding environment information may include information about whether a wall exists in a vicinity of the first object.

In addition, the shape information about the first object may be obtained by the object detection sensor 20. Here, the shape information about the first object may include information about an area or a width of the first object. In this instance, the memory 302 may store information about the general area and width of a door threshold.

The at least one processor 301 may determine whether the first object corresponds to a first door threshold based on information about whether a wall exists in a vicinity of the first object and information about the area or width of the first object.

In addition, the at least one processor may determine that the first object corresponds to the first door threshold based on whether the height of the first object is less than a reference height.

Here, the reference height may be set to an appropriate value to determine the door threshold that the cleaning robot 1 may traverse.

In FIG. 6, walls exist in a vicinity of the object 3 O3, and an area and width of the object 3 O3 may correspond to information about area and width of a door threshold stored in the memory. In addition, as shown in FIG. 7A, in a case where the height I1 of object 3 O3 is less than the reference height, the object 3 O3 may be determined to correspond to a door threshold.

In addition, as shown in FIG. 7B, in a case where the height I2 of object 3 O3 is greater than or equal to the reference height, the object 3 O3 may be determined as an obstacle, not a door threshold.

As such, whether the first object corresponds to a door threshold may be determined based on the surrounding environment information, shape information, and height of the first object.

The at least one processor 301 may reset a driving path of the cleaning robot 1 based on determining whether the first object corresponds to the first door threshold (505). For example, after completing cleaning in a cleaning space R, the driving path may be reset to traverse the first door threshold and move to another cleaning space.

The at least one processor 301 may transmit information about the result of determining whether the first object corresponds to the first door threshold and information about the reset driving path to an external device via the communication interface 90 (507).

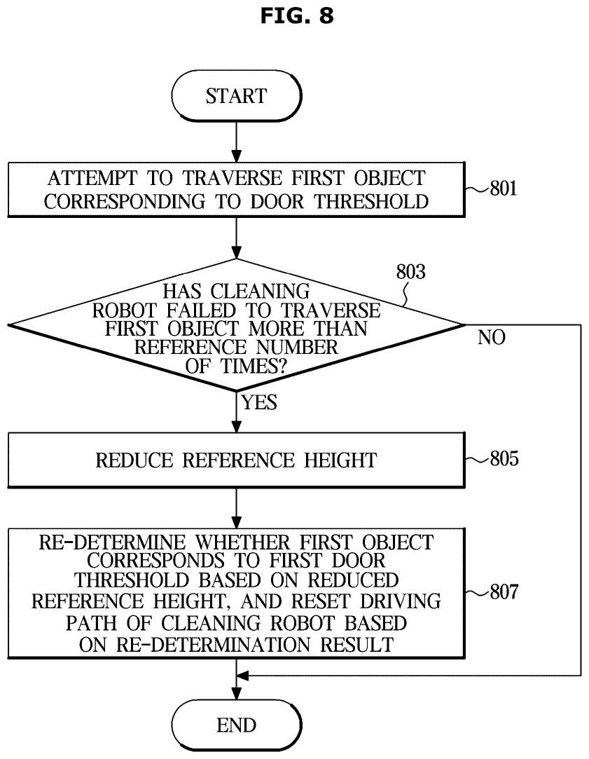

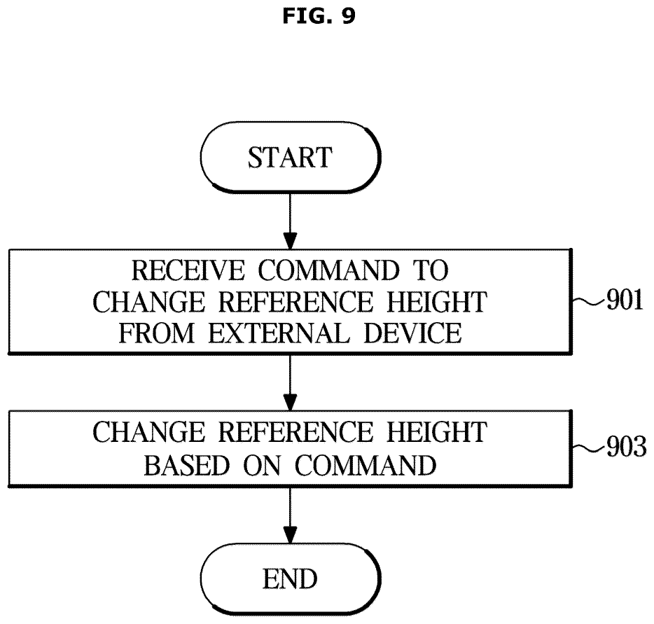

FIG. 8 is a flowchart illustrating a process of attempting a door threshold traversal and reducing a reference height according to an embodiment of the disclosure. FIG. 9 is a flowchart illustrating a process of changing a reference height according to user input according to an embodiment of the disclosure.

The at least one processor 301 may control the cleaning robot 1 to attempt to traverse the first object corresponding to the first door threshold (801).

However, even in a case where the first object is determined to correspond to the first door threshold, there may be cases where the cleaning robot 1 is not able to traverse due to environmental factors.

Accordingly, in a case where the cleaning robot 1 fails to traverse the first object, determined as the first door threshold, more than a reference number of times (Yes in operation 803), the at least one processor 301 may reduce a reference height for determining the first object to be the first door threshold (805). That is, the preset reference height may be determined too high for the cleaning robot 1 to traverse, and thus the reference height may be reduced.

The at least one processor 301 may re-determine whether the first object corresponds to the first door threshold based on the reduced reference height, and may reset a driving path of the cleaning robot 1 based on a re-determination result (807).

The reference height may be changed automatically in response to the failure of the traversal attempt described above, as well as according to user input, and the like.

That is, the at least one processor 301 may change the reference height (903), based on receiving a command to change the reference height from an external device via the communication interface (901).

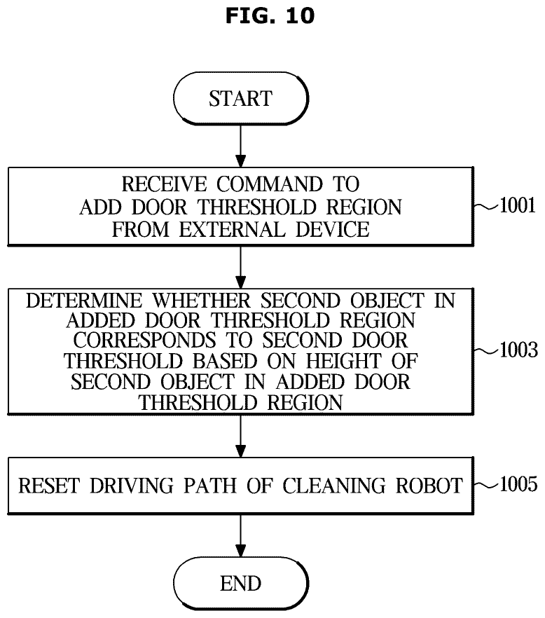

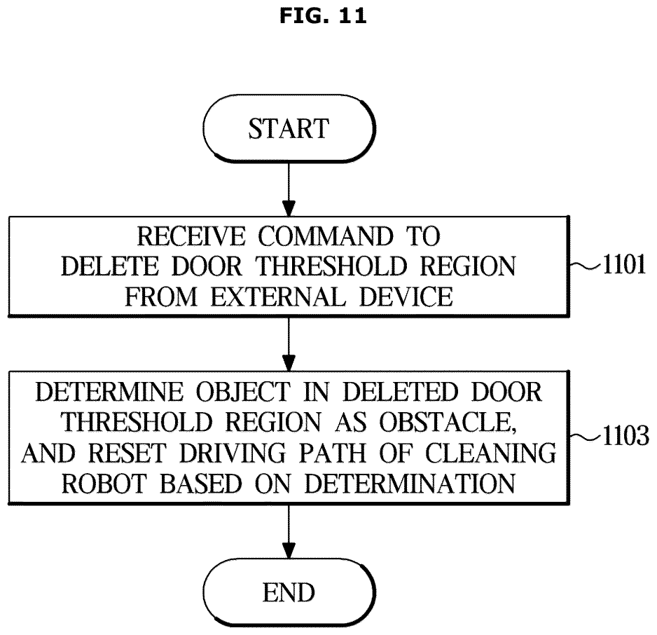

FIG. 10 is a flowchart illustrating a process of adding a door threshold region according to user input according to an embodiment of the disclosure. FIG. 11 is a flowchart illustrating a process of deleting a door threshold region according to user input according to an embodiment of the disclosure.

In response to receiving an input (command) to add a door threshold region from an external device (1001), the at least one processor 301 may determine whether a second object in the added door threshold region corresponds to a second door threshold based on a height of the second object in the added door threshold region (1003).

That is, whether the second object in the added door threshold region corresponds to a second door threshold may be determined by the above-described process of determining whether an object corresponds to a door threshold.

The at least one processor 301 may reset a driving path of the cleaning robot 1 based on determining whether the second object corresponds to the second door threshold (1005).

In addition, in response to receiving an input (command) to delete a door threshold region from an external device (1101), the at least one processor 301 may identify whether a third object in the deleted door threshold region is an obstacle, and may reset a driving path of the cleaning robot 1 based on the third object being identified as the obstacle (1103).

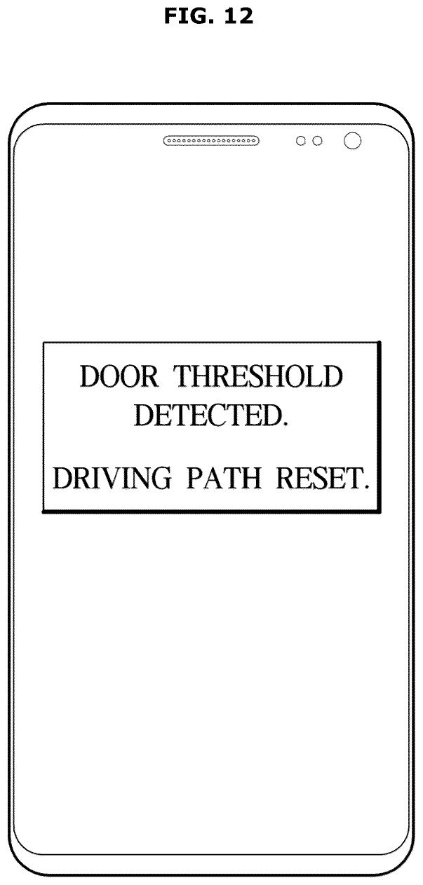

FIG. 12 is a diagram illustrating a notification provided to an external device according to an embodiment of the disclosure.

As described above, the at least one processor 301 may transmit information about the result of determining whether the first object corresponds to the first door threshold and information about the reset driving path to an external device via the communication interface 90.

That is, the at least one processor 301 may transmit the information about the detection result of the first object as corresponding to the first door threshold, information about whether the first door threshold may be traversed, or information about the driving path that is reset based on the determination that the first object corresponds to the first door threshold, to an external device, such as a user terminal, via the communication interface 90.

In addition, various information, such as information about a change in reference height, information about a driving path that is reset according to the change in reference height, and information about addition/deletion of a door threshold region may be transmitted to an external device, such as a user terminal, via the communication interface 90.

Accordingly, a notification, such as “Door threshold detected. Driving path reset” may be provided to an external device, such as a user's smartphone.

However, the above notification phrase is merely an example, and notifications may be provided in various forms, such as information being displayed on an application installed on a user terminal, or the like.

Thus, the user may easily recognize information about the door threshold, which may increase user convenience.

According to an embodiment of the disclosure, a cleaning robot may include: at least one wheel; an object detection sensor configured to obtain detection information corresponding to a first object; memory configured to store a cleaning space map including shape information and surrounding environment information for the first object; and at least one processor configured to identify a height of the first object, the shape information, and the surrounding environment information based on the detection information, and to determine whether the first object corresponds to a first door threshold that is traversable based on the identified height, the identified shape information, and the identified surrounding environment information, and in response to the determination, control the at least one wheel to move the cleaning robot to traverse the first object.

According to the disclosure, the cleaning robot and the method for controlling the same may automatically detect a door threshold during driving and establish an optimized driving plan according to the characteristics of the detected door threshold.

In addition, the cleaning robot and the method for controlling the same may enable efficient cleaning by automatically determining whether the cleaning robot may traverse a door threshold according to the height of the door threshold and setting a driving path based on the determination.

The at least one processor may be configured to determine that the first object corresponds to the first door threshold based on whether the height of the first object is less than a reference height.

The at least one processor may be configured to reduce the reference height, in response to the cleaning robot failing to traverse the first object determined as the first door threshold more than a reference number of times.

The at least one processor may be configured to re-determine whether the first object corresponds to the first door threshold based on the reduced reference height, and reset a driving path of the cleaning robot based on a re-determination result.

The cleaning robot may further include a communication interface configured to communicate with an external device, and the at least one processor may be configured to change the reference height based on a command to change the reference height, the command being received from the external device via the communication interface.

The cleaning robot may further include a communication interface configured to communicate with an external device, and the at least one processor may be configured to, in response to receiving an input to add a door threshold region from the external device, determine whether a second object in the added door threshold region corresponds to a second door threshold based on a height of the second object in the added door threshold region.

The at least one processor may be configured to, in response to receiving an input to delete a door threshold region from the external device, identify whether a third object in the deleted door threshold region is an obstacle, and reset a driving path of the cleaning robot based on the third object being identified as the obstacle.

The at least one processor may be configured to reset a driving path of the cleaning robot based on determining whether the first object corresponds to the first door threshold.

The shape information about the first object may include information about an area or a width of the first object.

The surrounding environment information may include information about whether a wall exists in a vicinity of the first object.

The cleaning robot may further include a communication interface configured to communicate with an external device, and the at least one processor may be configured to transmit information about a result of determining whether the first object corresponds to the first door threshold and information about the reset driving path to the external device via the communication interface.

According to an embodiment of the disclosure, in a method for controlling a cleaning robot, the method may include: obtaining detection information corresponding to a first object via an object detection sensor; identifying a height of the first object, shape information of the first object, and surrounding environment information of the first object based on the detection information; storing a cleaning space map including the shape information and the surrounding environment information; determining whether the first object corresponds to a first door threshold that is traversable by the cleaning robot based on (i) the identified height, (ii) the shape information, and (iii) the surrounding environment information; and based on the first object corresponding to the first door threshold, controlling at least one wheel of the cleaning robot to move the cleaning robot to traverse the first object.

The determining of whether the first object corresponds to the first door threshold may include determining that the first object corresponds to the first door threshold based on the height of the first object being less than a reference height.

The method may further include reducing the reference height in response to the cleaning robot failing to traverse the first object determined to correspond to the first door threshold more than a reference number of times.

The method may further include, in response to the reference height being reduced: re-determining whether the first object corresponds to the first door threshold; and resetting a driving path of the cleaning robot based on a result of the re-determination.

The method may further include changing the reference height based on receiving a command, via a communication interface, from an external device.

The method may further include: receiving an input to add a door threshold region from an external device via a communication interface; and determining whether a second object in the door threshold region corresponds to a second door threshold based on an identified height of the second object.

The method may further include, in response to receiving an input from an external device to delete a door threshold region, resetting a driving path of the cleaning robot based on identifying a third object in the deleted door threshold region as an obstacle.

The method may further include resetting a driving path of the cleaning robot based on determining whether the first object corresponds to the first door threshold.

The shape information about the first object may include information about an area or a width of the first object.

The surrounding environment information may include information about whether a wall exists in a vicinity of the first object.

The method may further include transmitting information about a result of determining whether the first object corresponds to the first door threshold and information about the reset driving path to an external device.

According to the disclosure, a cleaning robot and a method for controlling the same may automatically detect a door threshold during driving and establish an optimized driving plan according to the characteristics of the detected door threshold.

In addition, the cleaning robot and the method for controlling the same may enable efficient cleaning by automatically determining whether the cleaning robot may traverse a door threshold according to the height of the door threshold and setting a driving path based on the determination.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a non-transitory computer-readable recording medium.

For example, a non-transitory computer-readable recording medium may have at least one instruction recorded thereon, that, when executed by at least one processor of a cleaning robot, individually or collectively, causes the at least one processor to obtain detection information corresponding to an object via the object detection sensor; identify a height of the object, shape information of the object, and surrounding environment information of the object based on the detection information; store a cleaning space map including the shape information and the surrounding environment information, determine whether the object corresponds to a door threshold that is traversable by the cleaning robot based on (i) the height, (ii) the shape information, and (iii) the surrounding environment information; and based on the object corresponding to the door threshold, control at least one wheel of the cleaning robot to move the cleaning robot to traverse the object.

What is claimed is:

1. A cleaning robot, comprising:
at least one wheel;
an object detection sensor;
memory storing at least one instruction; and
at least one processor,
wherein the at least one instruction, when executed by the at least one processor, individually or collectively, causes the cleaning robot to:
obtain detection information corresponding to a first object via the object detection sensor;
identify a height of the first object, shape information of the first object, and surrounding environment information of the first object based on the detection information;
store a cleaning space map including the shape information and the surrounding environment information;
determine whether the first object corresponds to a first door threshold that is traversable by the cleaning robot based on (i) the height, (ii) the shape information, and (iii) the surrounding environment information; and
based on the first object corresponding to the first door threshold, control the at least one wheel to move the cleaning robot to traverse the first object.

2. The cleaning robot of claim 1, wherein the at least one instruction, when executed by the at least one processor, individually or collectively, causes the cleaning robot to determine that the first object corresponds to the first door threshold based on the height of the first object being less than a reference height.

3. The cleaning robot of claim 2, wherein the at least one instruction, when executed by the at least one processor, individually or collectively, causes the cleaning robot to reduce the reference height in response to the cleaning robot failing to traverse the first object more than a reference number of times.

4. The cleaning robot of claim 3, wherein the at least one instruction, when executed by the at least one processor, individually or collectively, causes the cleaning robot to, in response to the reference height being reduced:
re-determine whether the first object corresponds to the first door threshold; and
reset a driving path of the cleaning robot based on a result of the re-determination.

5. The cleaning robot of claim 2, further comprising a communication interface, wherein the at least one instruction, when executed by the at least one processor, individually or collectively, causes the cleaning robot to change the reference height based on receiving a command, via the communication interface, from an external device.

6. The cleaning robot of claim 1, further comprising a communication interface, wherein the at least one instruction, when executed by the at least one processor, individually or collectively, causes the cleaning robot to:
receive an input to add a door threshold region from an external device via the communication interface; and
determine whether a second object in the door threshold region corresponds to a second door threshold based on an identified height of the second object.

7. The cleaning robot of claim 6, wherein the at least one instruction, when executed by the at least one processor, individually or collectively, causes the cleaning robot to, in response to receiving an input to delete a door threshold region from the external device, reset a driving path of the cleaning robot based on identifying a third object in the deleted door threshold region as an obstacle.

8. The cleaning robot of claim 1, wherein the at least one instruction, when executed by the at least one processor, individually or collectively, causes the cleaning robot to reset a driving path of the cleaning robot based on determining whether the first object corresponds to the first door threshold.

9. The cleaning robot of claim 1, wherein the shape information comprises information indicating at least one of an area of the first object or a width of the first object.

10. The cleaning robot of claim 1, wherein the surrounding environment information comprises information indicating whether a wall exists in a vicinity of the first object.

11. The cleaning robot of claim 8, further comprising a communication interface, wherein the at least one instruction, when executed by the at least one processor, individually or collectively, causes the cleaning robot to transmit to the external device, via the communication interface: (i) information indicating whether the first object corresponds to the first door threshold and (ii) information indicating the driving path that was reset.

12. A method for controlling a cleaning robot comprising:
obtaining detection information corresponding to an object via the object detection sensor;
identifying a height of the object, shape information of the object, and surrounding environment information of the object based on the detection information;
storing a cleaning space map including the shape information and the surrounding environment information;
determining whether the object corresponds to a door threshold that is traversable by the cleaning robot based on (i) the height, (ii) the shape information, and (iii) the surrounding environment information; and
based on the object corresponding to the door threshold, controlling at least one wheel of the cleaning robot to move the cleaning robot to traverse the object.

13. The method of claim 12, wherein the determining whether the object corresponds to the door threshold comprises determining that the object corresponds to the door threshold based on the height of the object being less than a reference height.

14. The method of claim 13, further comprising reducing the reference height in response to the cleaning robot failing to traverse the object more than a reference number of times.

15. The method of claim 14, further comprising, in response to the reference height being reduced:
re-determining whether the object corresponds to the door threshold; and
resetting a driving path of the cleaning robot based on a result of the re-determination.

16. The method of claim 13, further comprising changing the reference height, based on receiving a command, via a communication interface, from an external device.

17. The method of claim 12, further comprising:
receiving an input to add a door threshold region from an external device via the communication interface; and
determining whether a second object in the door threshold region corresponds to a second door threshold based on an identified height of the second object.

18. The method of claim 17, further comprising, in response to receiving an input to delete a door threshold region from the external device, resetting a driving path of the cleaning robot based on identifying a third object in the deleted door threshold region as an obstacle.

19. The method of claim 12, further comprising resetting a driving path of the cleaning robot based on determining whether the first object corresponds to the first door threshold.

20. A non-transitory computer-readable recording medium having at least one instruction recorded thereon, that, when executed by at least one processor of a cleaning robot, individually or collectively, causes the at least one processor to:
obtain detection information corresponding to an object via the object detection sensor;
identify a height of the object, shape information of the object, and surrounding environment information of the object based on the detection information;
store a cleaning space map including the shape information and the surrounding environment information;
determine whether the object corresponds to a door threshold that is traversable by the cleaning robot based on (i) the height, (ii) the shape information, and (iii) the surrounding environment information; and
based on the object corresponding to the door threshold, control at least one wheel of the cleaning robot to move the cleaning robot to traverse the object.
